(19) United States
(12) Patent Application Publication
(10) Pub. No.: US 2014/0189584 A1
(43) Pub. Date: Jul. 3, 2014

(54) METHOD FOR SWITCHING APPLICATIONS IN USER INTERFACE AND ELECTRONIC APPARATUS USING THE SAME

(71) Applicant: COMPAL COMMUNICATIONS, INC., Taipei (TW)

(72) Inventors: Ming-Che Weng, Taipei (TW); Chieh-Yu Chan, Taipei (TW); Hsiu-Hang Lin, Taipei (TW); Ming-Yuan Weng, Taipei (TW); Yen-Hui Li, Taipei (TW); Yung-Ching Tien, Taipei (TW)

(73) Assignee: COMPAL COMMUNICATIONS, INC., Taipei (TW)

(21) Appl. No.: 13/727,617

(22) Filed: Dec. 27, 2012

(51) Int. Cl. G06F 3/0484; G06F 3/048

(52) U.S. Cl. CPC G06F 3/04847
USPC 715/808; 715/833

(57) ABSTRACT

A method for switching applications in a user interface and an electronic apparatus using the same are disclosed herein. The method includes the following steps. Firstly, execute a first application after being unlocked, and detect a sliding operation. Next, determine whether the sliding operation matches a first direction or a second direction. If yes, correspondingly displaying an icon page of a second application. Afterwards, determine whether the sliding operation matching the first direction or the second direction is detected again in a predetermined time. If no, executing the second application.

### BACKGROUND

1. Field of the Invention

The invention relates to a switching method, in particular, to a method for switching applications in a user interface.

2. Description of Related Art

Nowadays, various electronic devices have become a very important part of people's life. For example, devices such as the smartphone, tablet, notebook and personally digital assistant (PDA) become one of the most frequently used products for the provided convenience.

For conveniences of users, lots of periphery devices have been developed. Recently, the designers of the electronic devices further link electronic watches and the electronic devices, such that the users may operate or manage the functions of the electronic devices through the electronic watches. However, since the user interface of the electronic watches are basically designed in a simplified manner, such that the user may feel inconvenient while switching the applications in the user interface of the electronic watches.

### SUMMARY

Accordingly, the present invention is directed to a method for switching applications in a user interface and an electronic apparatus using the same, which provide the user a novel, simple and intuitive way to switch the applications in the electronic apparatus.

A method for switching applications in a user interface is introduced herein, which can be adapted for an electronic apparatus. The method includes the following steps. Firstly, execute a first application after being unlocked, and detect a sliding operation. Next, determine whether the sliding operation matches a first direction or a second direction. If yes, correspondingly displaying an icon page of a second application. Afterwards, determine whether the sliding operation matching the first direction or the second direction is detected again in a predetermined time. If no, executing the second application.

In an embodiment of the present invention, after the step of determining whether the sliding operation matches the first direction or the second direction, the method further includes: when the sliding operation does not match the first direction or the second direction, displaying corresponding pages according to a direction of the sliding operation.

In an embodiment of the present invention, after the step of determining whether the sliding operation matching the first direction or the second direction is detected again in the predetermined time, the method further includes: when the sliding operation matching the first direction or the second direction is not detected again in the predetermined time, correspondingly displaying another icon page of another application.

In an embodiment of the present invention, the step of executing the second application includes: displaying a main page of the second application; and displaying corresponding pages according to a direction of the sliding operation. When the direction of the sliding operation matches a third direction, display a notification page.

In an embodiment of the present invention, after the step of executing the second application, the method further includes: switching to an application list in response to a long touch operation, wherein the applications list consists of a plurality of applications of the electronic apparatus.

In an embodiment of the present invention, the method further includes establishing a wireless connection with a mobile phone.

In an embodiment of the present invention, the method further includes displaying at least one pop-up notification related to the mobile phone, wherein the at least one pop-up notification includes a calendar event, a message, a missed call, a battery condition of the mobile phone and a disconnection of the wireless connection.

In an embodiment of the present invention, the method further includes providing calling functions through the wireless connection.

In an embodiment of the present invention, the step of providing the calling functions through the wireless connection includes: displaying an incoming call page after detecting that the mobile phone has received an incoming call, wherein the incoming call page includes an answer button; and picking up the incoming call after detecting the answer button has been pressed.

In an embodiment of the present invention, when the wireless connection disappears, hide at least one specific application related to the mobile phone.

From another point of view, an electronic apparatus is introduced herein. The electronic apparatus includes a touch display and a processing unit. The processing unit is coupled to the touch display and configured to execute the program instructions to execute a method for switching applications in a user interface, comprising: executing a first application after being unlocked; controlling the touch display to detect a sliding operation; determining whether the sliding operation matches a first direction or a second direction; if yes, controlling the touch display to correspondingly displaying an icon page of a second application; determining whether the sliding operation matching the first direction or the second direction is detected again in a predetermined time; and if no, executing the second application.

In an embodiment of the present invention, when the processing unit determines that the sliding operation does not match the first direction or the second direction, the touch display displays corresponding pages according to a direction of the sliding operation.

In an embodiment of the present invention, when the processing unit determines that the sliding operation matching the first direction or the second direction is not detected again in the predetermined time, the touch display correspondingly displays another icon page of another application.

In an embodiment of the present invention, after the processing unit executes the second application, the touch display displays a main page of the second application, and displays corresponding pages according to a direction of the sliding operation. When the processing unit determines that the direction of the sliding operation matches a third direction, the touch display displays a notification page.

In an embodiment of the present invention, after the processing unit executes the second application, the touch display switches to an application list in response to a long touch operation, wherein the applications list consists of a plurality of applications of the electronic apparatus.

In an embodiment of the present invention, the electronic apparatus further includes a communication unit, configured for establishing a wireless connection with a mobile phone.

In an embodiment of the present invention, the touch display displays at least one pop-up notification related to the mobile phone, wherein the at least one pop-up notification includes a calendar event, a message, a missed call, a battery condition of the mobile phone and a disconnection of the wireless connection.

In an embodiment of the present invention, the communication unit further provides calling functions through the wireless connection.

In an embodiment of the present invention, the touch display displays an incoming call page after the communication unit detects that the mobile phone has received an incoming call, wherein the incoming call page includes an answer button; and the communication unit picks up the incoming call after detecting the answer button has been pressed.

In an embodiment of the present invention, when the wireless connection disappears, the processing unit hides at least one specific application related to the mobile phone.

Based on the above description, the embodiments of the present invention provide a novel, simple and intuitive way to switch the applications in the electronic apparatus. When the sliding operation from the user is detected, the electronic apparatus may correspondingly switch to display an icon page of another application. Next, instead instantly executing the application while displaying the icon page, the electronic apparatus would detect whether another sliding operation is detected in the following predetermined time. If no, the electronic apparatus would execute the application. Therefore, the user may switch the applications by the sliding operations without touching any screen buttons of the applications, and would feel a new user experience.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating an electronic apparatus according to an exemplary embodiment of the present invention.

FIG. 2 is a flow chart illustrating a method for switching applications in a user interface according to an exemplary embodiment of the present invention.

FIG. 3A is a schematic diagram illustrating the idle screen of the electronic apparatus according to an exemplary embodiment of the present invention.

FIG. 3B is a schematic diagram illustrating the home screen of the electronic apparatus according to the embodiment of FIG. 3A.

FIG. 3C is a schematic diagram illustrating the display screen of the edit mode according to the embodiment of FIG. 3A.

FIG. 3D is a schematic diagram illustrating the display screen of the clock style setting mode according to the embodiment of FIG. 3C.

FIG. 4 is a schematic diagram illustrating the switching mechanism among applications according to an exemplary embodiment of the present invention.

FIG. 5 is a schematic diagram illustrating the display screen after the electronic apparatus executes the application according to an exemplary embodiment of the present invention.

FIG. 6 is a schematic diagram illustrating the transition mechanism to the application list according to an exemplary embodiment of the present invention.

FIG. 7 is a schematic diagram illustrating the related applications without the wireless connection between the electronic apparatus and the mobile phone according to an exemplary embodiment of the present invention.

FIG. 8A is a schematic diagrams illustrating the pop-up notification of a missed call related to the mobile phone according to an exemplary embodiment of the present invention.

FIG. 8B is a schematic diagram illustrating the pop-up notification of a message related to the mobile phone according to an exemplary embodiment of the present invention.

FIG. 8C is a schematic diagram illustrating the pop-up notification of a low battery condition related to the mobile phone according to an exemplary embodiment of the present invention.

FIG. 8D is a schematic diagram illustrating the pop-up notification of disconnection of the wireless connection according to an exemplary embodiment of the present invention.

FIG. 8E is a schematic diagram illustrating the pop-up notification of a calendar event related to the mobile phone according to an exemplary embodiment of the present invention.

FIG. 8F is another schematic diagram illustrating the pop-up notification of a calendar event related to the mobile phone according to the embodiment of FIG. 8E.

FIG. 9A is a schematic diagram illustrating processing an incoming call of the mobile phone according to an exemplary embodiment of the present invention.

FIG. 9B is a schematic diagram illustrating performing the voice dial function to the mobile phone according to an exemplary embodiment of the present invention.

### DETAILED DESCRIPTION OF DISCLOSED EMBODIMENTS

Some embodiments of the present application will now be described more fully hereinafter with reference to the accompanying drawings, in which some, but not all embodiments of the application are shown. Indeed, various embodiments of the application may be embodied in many different forms and should not be construed as limited to the embodiments set forth herein; rather, these embodiments are provided so that this disclosure will satisfy applicable legal requirements. Like reference numerals refer to like elements throughout.

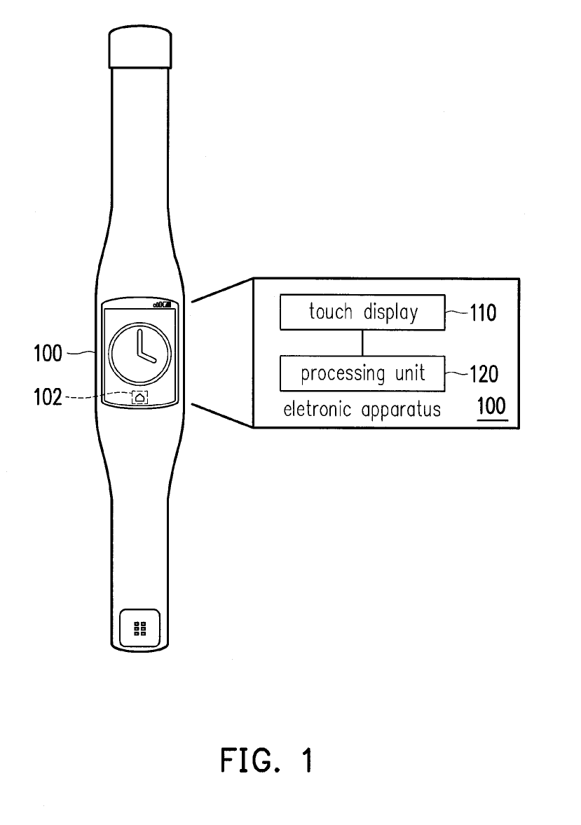

FIG. 1 is a schematic diagram illustrating an electronic apparatus according to an exemplary embodiment of the present invention. In the present embodiment, an electronic apparatus 100 includes a touch display 110 and a processing unit 120. The touch display 110 may be, for example, implemented in a capacitive style, a resistive style or a wave style, but is not limited thereto. The processing unit 120 is coupled to the touch display 110, and may be, for example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, an ARM-based processor, and the like. In other embodiments, the electronic apparatus 100 may further include a communication unit (not shown), which may be configured for establishing a wireless connection with a mobile phone.

For brevity, it should be noted that in the following paragraph of the present invention, the operation of the elements of the electronic apparatus 100 other than the processing unit 120 are based on the control of the processing unit 120. Therefore, the controlling operation performed by the processing unit 120 to other elements of the electronic apparatus 100 would be omitted.

The electronic apparatus 100 may be, for example, an electronic watch, which may be configured for communicating with the mobile phone through the wireless connection. Through the wireless connection, the electronic apparatus 100 may access the data and information stored in the mobile phone, such as missed calls, time, messages, calendar events, but the invention is not limited thereto. The wireless connection may be, for example, a Bluetooth connection or the like.

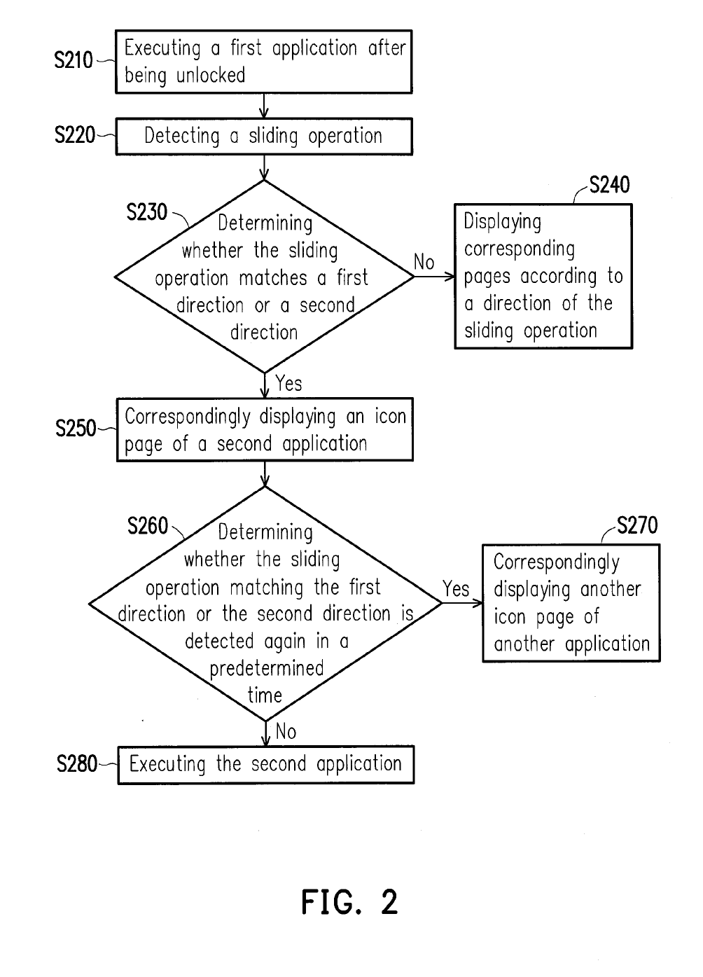

FIG. 2 is a flow chart illustrating a method for switching applications in a user interface according to an exemplary embodiment of the present invention. Referring to both FIG. 1 and FIG. 2, the proposed method for switching the applications in the user interface may be adapted for the electronic apparatus 100, but the invention is not limited thereto. As other electronic devices having touch displays, the electronic apparatus 100 is designed to have a locked mode (or sleep mode), in which the touch display 110 may display an idle screen.

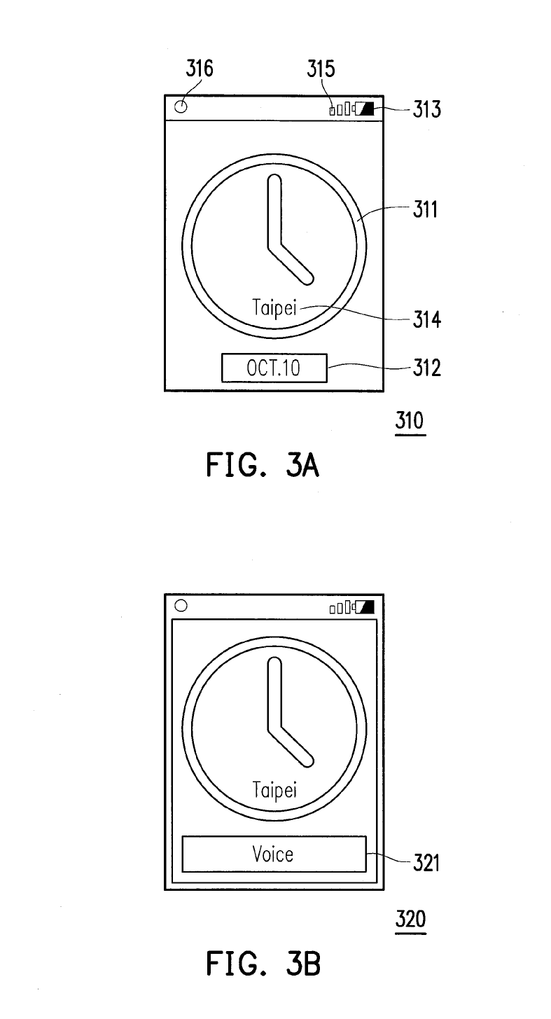

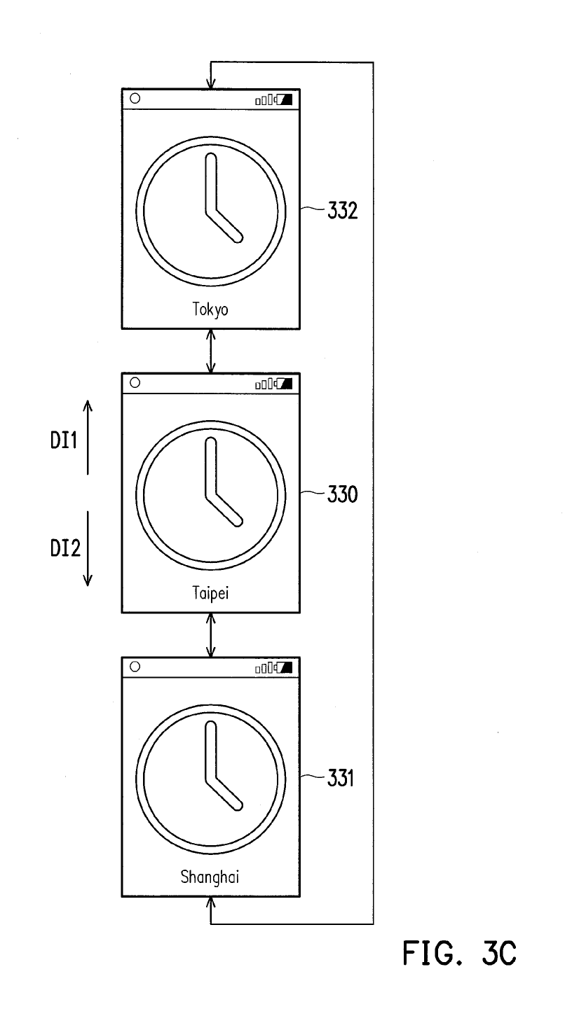

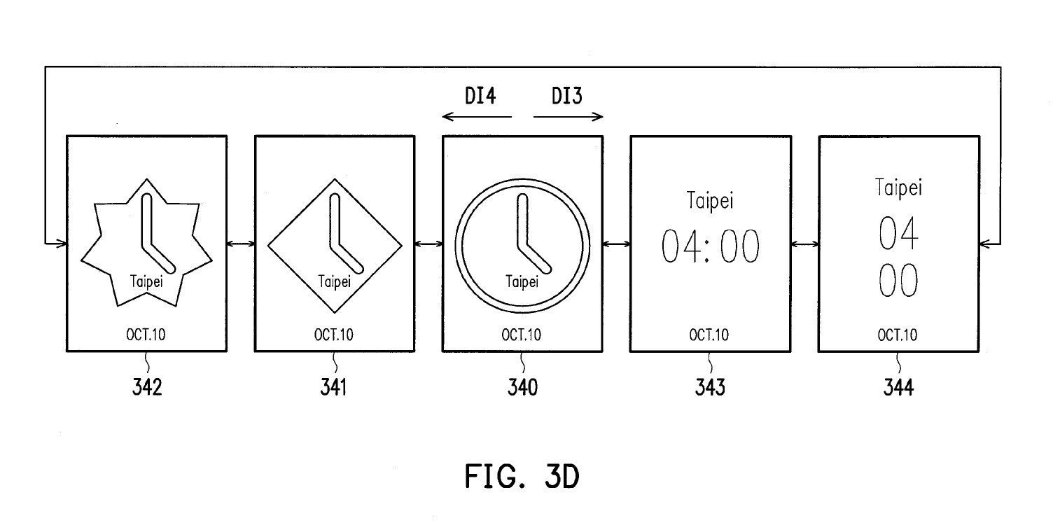

FIG. 3A is a schematic diagram illustrating the idle screen of the electronic apparatus according to an exemplary embodiment of the present invention. As shown in FIG. 3A, in the locked mode (or sleep mode), the touch display 110 may display an idle screen 310, which may display some conventional information of a watch, such as time 311, date 312 and the battery condition 313 of the electronic apparatus 100. Besides, when the wireless connection (e.g., the Bluetooth connection) has been established between the electronic apparatus 100 and the mobile phone, the idle screen may further display some information related to the mobile phone, such as a time zone 314, the signal strength 315 of the wireless connection and a notification sign 316 for indicating whether there exist notifications on the mobile phone. The notifications on the mobile phone may be, for example, missed calls, calendar events, messages or the like. Besides, the notification sign 316 may also indicate whether there exist notifications on the electronic apparatus 100, such as low battery and the disconnection with the mobile phone.

Referring to both FIG. 1 and FIG. 2, in step S210, the processing unit 120 may execute a first application after being unlocked. Specifically, in the present embodiment, the electronic apparatus 100 may be equipped with a power button (not shown) and a home button 102 (illustrated in FIG. 1). When the electronic apparatus 100 is in the locked mode (or the sleep mode), the user of the electronic apparatus 100 may unlock the touch display 110 by pressing the power button. When the power button is pressed, the processing unit 120 may execute the first application, which may be a clock application. Next, the touch display 110 may display a main page of the first application (e.g., the clock application). In the present embodiment, the main page of the first application may be regarded as a home screen of the electronic apparatus 100. Therefore, whenever the home button 102 is pressed, the touch display 110 would correspondingly display the home screen, but the invention is not limited thereto.

FIG. 3B is a schematic diagram illustrating the home screen of the electronic apparatus according to the embodiment of FIG. 3A. In the present embodiment, the main difference between the home screen 320 and the idle screen 310 (in FIG. 3A) is that the home screen 320 further includes a voice dial button 321. The detailed description of the related functions of the voice dial button 321 would be provided later.

In other embodiments, the configuration of the clock application may be adjusted by the user, such as the clock style, time zone or the like. In here, the processing unit 120 may be configured to execute an edit mode when the power button is triggered twice when the electronic apparatus 100 is in the locked mode, but the invention is not limited thereto.

FIG. 3C is a schematic diagram illustrating the display screen of the edit mode according to the embodiment of FIG. 3A. In the present embodiment, when the processing unit 120 executes the edit mode, the processing unit 120 may perform data synchronization with the mobile phone for obtaining the time zone of the mobile phone. For example, the time zone of the mobile phone may belong to Taipei as shown in the display screen 330. At this time, the processing unit 120 may change the time zone in response to the user's sliding operation. For example, assuming there are three default time zones of the mobile phone (e.g., Tokyo, Taipei and Shanghai), and the user may change the time zone by, for example, sliding upward or downward. When the user slides upward (i.e., along a first direction DI1) to the display screen 330, the touch display 110 may correspondingly switch to a display screen 331, which displays the time zone of Shanghai. When the user slides downward (i.e., along a second direction DI2) to the display screen 330, the touch display 110 may correspondingly switch to a display screen 332, which displays the time zone of Tokyo. After the user selects the desired time zone by, for example, tapping the touch display 110, the processing unit 120 may correspondingly save the change and go back to the home screen 320, but the invention is not limited thereto.

Herein, the arrangement of the display screens 330-332 may be designed in a loop way. That is, when the user slides upward (i.e., along the first direction DI1) to the display screen 331, the touch display 110 may correspondingly switch to the display screen 332, which displays the time zone of Tokyo. When the user slides downward (i.e., along the second direction DI2) to the display screen 332, the touch display 110 may correspondingly switch to a display screen 331, which displays the time zone of Shanghai.

Besides, after the processing unit 120 executes the edit mode, the processing unit 120 may also change the clock style in response to the user's input. For example, when the touch display 110 is displaying the display screen 330, the touch display 110 may detect a touch event. Next, the processing unit 120 may determine whether the duration of the touch event is over a first predetermined time (e.g., 1 second). When the duration of the touch event is over the first predetermined time (e.g., 1 second), the processing unit 120 may execute a clock style setting mode.

FIG. 3D is a schematic diagram illustrating the display screen of the clock style setting mode according to the embodiment of FIG. 3C. In the present embodiment, after the processing unit 120 executes the clock style setting mode, the touch display 110 may display the display screen 340. Next, the processing unit 120 may switch the clock style in response to the user's sliding operation. For example, assuming there are five default clock styles (respectively corresponding to display screens 340-344) of the mobile phone, and the user may change the clock style by, for example, sling rightward or leftward. When the user slides rightward (i.e., along a third direction DI3) to the display screen 340, the touch display 110 may correspondingly switch to a display screen 341. When the user slides leftward (i.e., along a fourth direction DI4) to the display screen 340, the touch display 110 may correspondingly switch to a display screen 343.

People with ordinary skills in the art should be able to understand that when the user slides rightward or leftward to the display screen other than the display screen 340, the touch display 110 would switch to the corresponding display screen according to the relative arrangement illustrated in FIG. 3D. For example, when the touch display 110 receives a rightward sliding operation while displaying the display screen 341, the touch display 110 may switch to the display screen 342; and when the touch display 110 receives a leftward sliding operation while displaying the display screen 341, the touch display 110 may switch to the display screen 340. Similar principles may be adapted to other display screens, which would not be described herein. After the user selects the desired clock style by, for example, tapping the touch display 110, the processing unit 120 may correspondingly save the change and go back to the home screen 320, but the invention is not limited thereto.

As shown in FIG. 3D, the arrangement of the display screens 340-344 may also be designed in the loop way. That is, when the user slides leftward (i.e., along the third direction DI3) to the display screen 342, the touch display 110 may correspondingly switch to the display screen 344. When the user slides leftward (i.e., along the fourth direction DI4) to the display screen 344, the touch display 110 may correspondingly switch to a display screen 342.

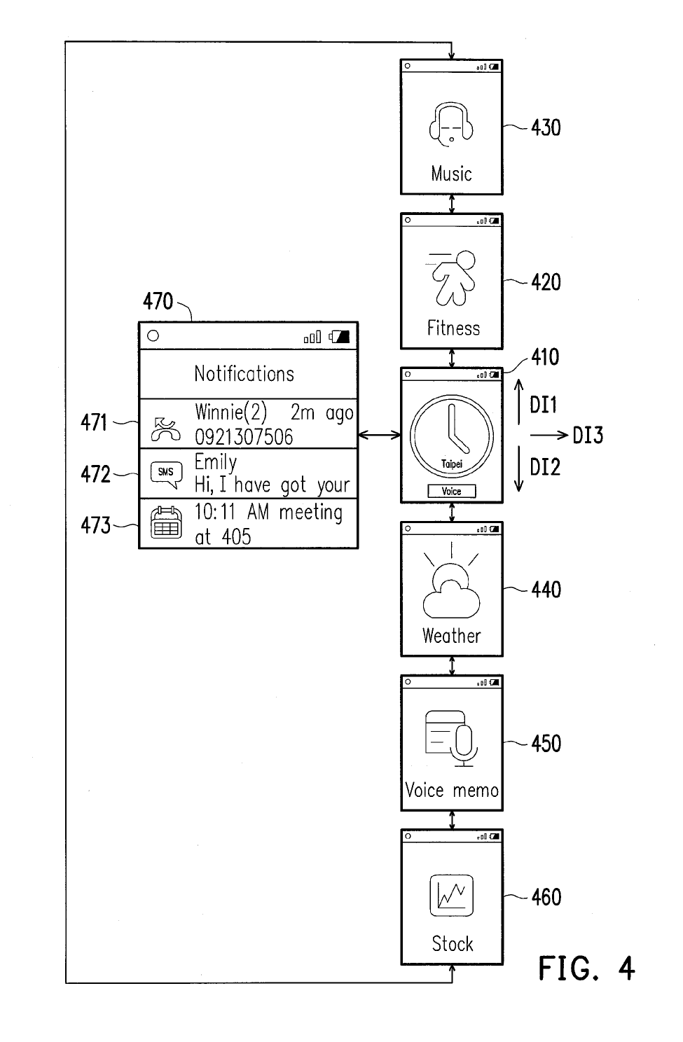

FIG. 4 is a schematic diagram illustrating the switching mechanism among applications according to an exemplary embodiment of the present invention. In the present embodiment, the electronic apparatus 100 may have applications, and each of the application may have an icon page, a main page, a sub page and a detailed page, but the invention is not limited thereto. For example, icon pages 410-460 may respectively correspond to a clock application, a fitness application, a music application, a weather application, a voice memo application and a stock application.

Referring to both FIG. 2 and FIG. 4, as mentioned in the previous embodiments, the processing unit 120 may execute the first application (e.g., the clock application corresponding to the icon page 410) after being unlocked (step S210). Next, in step S220, the processing unit 120 may control the touch display 110 to detect a sliding operation. In step S230, the processing unit 120 may determine whether the sliding operation matches the first direction DI1 or the second direction DI2. When the sliding operation does not match the first direction DI1 or the second direction DI2, in step S240, the processing unit 120 may control the touch display 110 to display corresponding pages according to a direction of the sliding operation. For example, since the electronic apparatus 100 may have notifications about the electronic apparatus 100 and the mobile phone, the processing unit 120 may construct a notification page 470 for recording the notifications. Hence, when the direction of the sliding operation matches a third direction DI3, the touch display 110 may switch to the notification page 470. The notification page 470 may include information such as a missed call 471, a message 472 on the mobile phone and a calendar event 473, but the invention is not limited thereto. In the notification page 470, the user may select the desired notification by touching the corresponding areas, and therefore the touch display 110 may show the detailed information about the selected application.

When the sliding operation matches the first direction DI1 or the second direction DI2, in step S250, the touch display 110 may correspondingly display an icon page of a second application. Specifically, in the present embodiment, since the user may switch applications by performing the sliding operation, the processing unit 120 may correspondingly adjust the displaying condition according to different applications. For example, when the user performs a sliding operation along the first direction DI1 while the touch display 110 is displaying the icon page 410, the touch display 110 may correspondingly display the icon page 440 of the weather application. For another example, when the user performs a sliding operation along the second direction DI2 while the touch display 110 is displaying the icon page 410, the touch display 110 may correspondingly display the icon page 420 of the fitness application.

However, it should be noted that the electronic apparatus 100 is just showing the icon page, instead of actually executing the corresponding application in step S250. In detail, since the user may switch back and forth among the applications to find the desired application, if the processing unit 120 instantly executes the corresponding application when displaying the icon page, there may appear some problems of multitask on the electronic apparatus 100, which would significantly decrease the performance of the electronic apparatus 100.

Hence, in step S260, the processing unit 120 may determine whether the sliding operation matching the first direction or the second direction is detected again in a predetermined time (e.g., 2 seconds). That is, before actually executing the application corresponding to the currently showing icon page, the processing unit 120 may wait for the predetermined time (e.g., 2 seconds) to confirm that the user really wants to execute this application. If the processing unit 120 determines that the sliding operation matching the first direction or the second direction is detected again in the predetermined time (e.g., 2 seconds), which represents that the user may want to execute other applications instead of the application corresponding to the currently displaying icon page. Therefore, the processing unit 120 may perform step S270.

In step S270, the touch display 110 may correspondingly display another icon page of another application. For example, at the moment the touch display 110 displaying the icon page 450, which corresponds to the voice memo application, the touch display 110 may start to detect whether the sliding operation matching the first direction or the second direction is detected in the predetermined time (e.g., 2 seconds). During the predetermined time, when the user performs a sliding operation along the first direction DI1, the electronic apparatus 100 would understand that the user does not really want to execute the voice memo application, and correspondingly display another icon page (i.e., the icon page 460) of another application (i.e., the stock application). Besides, the arrangement of the icon pages 410-460 may also be designed in the loop way, and the related description of the loop way may be referred to the embodiments of FIGS. 3C and 3D, which would not be further described herein.

However, if the processing unit 120 determines that the sliding operation matching the first direction or the second direction is not detected again in the predetermined time, the electronic apparatus 100 would understand that the user wants to execute the application corresponding to the currently displaying icon page, and perform step S280.

In step S280, the processing unit 120 may execute the second application, which is the application corresponding to the displayed icon page in step S250. Afterwards, the touch display 110 may display the main page of the second application and performing operations in response to the user's input.

As a result, the embodiments of the present invention provide a novel, simple and intuitive way to switch the applications in the user interface of the electronic apparatus. According to the contents of the embodiments, the user may execute the desired application through the sliding operation, instead of touching corresponding screen buttons. That is, the user may slide, for example, upward or downward to find the desired application. Once the user finds the icon page of the desired application, the user does not need to perform other operations to execute the desired application, but just wait for the predetermined time (e.g., 2 seconds). After the predetermined time, the processing unit 120 would automatically execute the application corresponding to the displayed icon page.

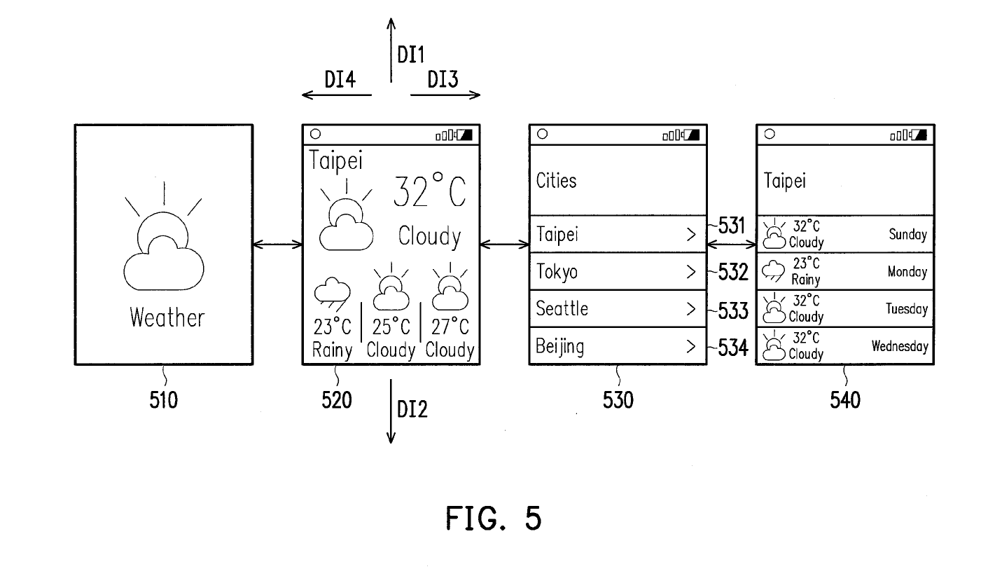

FIG. 5 is a schematic diagram illustrating the display screen after the electronic apparatus executes the application according to an exemplary embodiment of the present invention. In the present embodiment, it is assumed that the processing unit 120 executes the weather application, which has an icon page 510, a main page 520, a sub page 530 and a detailed page 540. As mentioned in the previous embodiments, before executing the weather application, the icon page 510 would be displayed for the predetermined time (e.g., 2 seconds), and then the touch display 110 may automatically switch to display the main page 520 of the weather application. The main page 520 may include information such as the temperature, weather conditions of the present city and icons related to the weather conditions or the like.

When the touch display 110 is displaying the main page 520, the touch display 110 may detect the sliding operation, and then switch pages according to the direction of the detected sliding operation. For example, when the direction of the detected sliding operation is along the first direction DI1 or the second direction DI2, the touch display 110 may switch to the icon pages corresponding to other applications. When the direction of the detected sliding operation is along the third direction DI3, the touch display 110 may display the notification page 470 as illustrated in FIG. 4. When the direction of the detected sliding operation is along the fourth direction DI4, the touch display 110 may display other pages related to the currently executing application (i.e., the weather application). For example, the touch display 110 may display the sub page 530, which includes screen buttons 531-534 labeled with international cities for facilitating the user to know the weather conditions of the listed cities.

When the touch display 110 is displaying the sub page 530, the processing unit 120 may still perform operations according to the direction of the sliding operation. For example, when the direction of the sliding operation is along the first direction DI1 or the second direction DI2, the touch display 110 may correspondingly scroll up/down the displayed contents in the sub page 530. When the direction of the sliding operation is along the third direction DI3, the touch display 110 may correspondingly switch to the previously displayed page (i.e., the main page 520). Besides, when the user touches the screen buttons 531-534, the touch display 110 may show some detailed information related to the touched screen button. For example, when the user touches the screen button 531, the touch display 110 may switch to display the detailed page 540, which may include the detailed information related to the screen button 531, such as the weather conditions in the following days.

When the touch display 110 is displaying the detailed page 540, the electronic apparatus may also perform operations according to the direction of the sliding operation. For example, when the direction of the sliding operation is along the first direction DI1 or the second direction DI2, the touch display 110 may correspondingly scroll up/down the displayed contents in the detailed page 540. When the direction of the sliding operation is along the third direction DI3, the touch display 110 may correspondingly switch to the previously displayed page (i.e., the sub page 530).

In some embodiments, for facilitating the selection of the desired application, the electronic apparatus 100 may be configured with an application list, which consists of the applications in the electronic apparatus 100 and may be displayed after the touch display 110 detects a long touch operation.

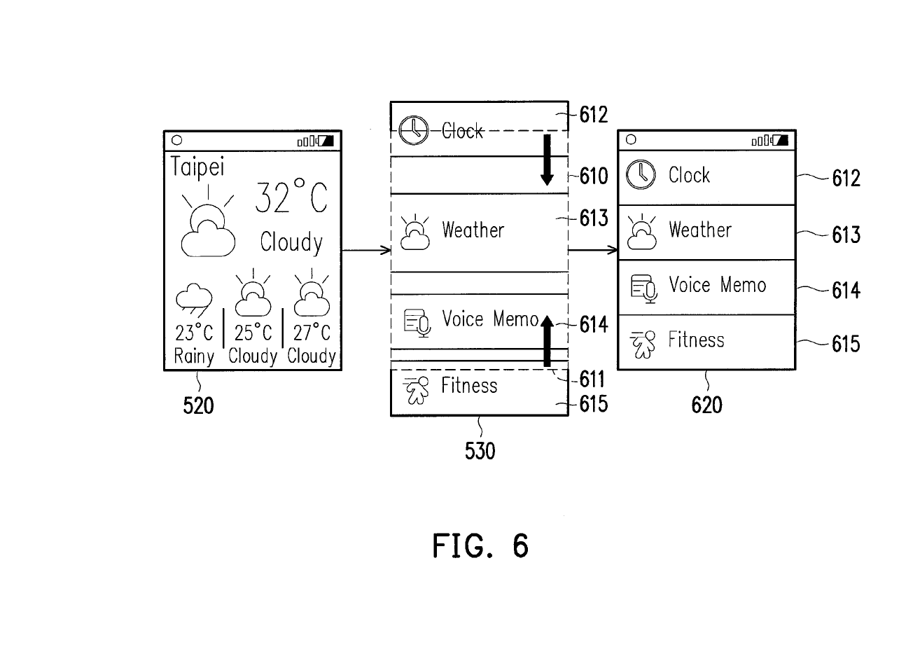

FIG. 6 is a schematic diagram illustrating the transition mechanism to the application list according to an exemplary embodiment of the present invention. In the present embodiment, the weather application is still considered as an example. After the processing unit 110 executes the weather application and displays the main page 520 of the weather application, the touch display 110 may switch to an application list 620 in response to the long touch operation of the user. The long touch operation may be a touch operation performed by the user through a long pressing gesture. In detail, when the touch display 110 detects that the duration of the touch operation of the user is over a second predetermined time (e.g., 1.5 seconds) while displaying the main page 520, the touch display 110 may firstly display a transition screen 610.

In the transition screen 610, assuming a screen range 611 represents the displaying range of the touch display 110, and screen buttons 612-615 respectively corresponds to different applications, the screen buttons 612-615 may slide into the screen range 611 from the top/bottom of the screen range 611. For example, the screen button 612 may slide from the top of the screen range 611 into the screen range 611; and the screen buttons 614-615 may slide from the bottom of the screen range 611 into the screen range 611, but the invention is not limited thereto. Besides, since the screen button 613 corresponds to the currently executing application (i.e., the weather application), the touch display 110 may directly display the screen button 613 at a specific position in the screen range 611.

The arrangement of the screen buttons 612-615 may be arranged according to the arrangement illustrated in FIG. 4. That is, according to the arrangement illustrated in FIG. 4, the previous application of the weather application is the clock application (corresponding to the screen button 612), and the next two applications of the weather application are the voice memo application (corresponding to the screen button 614) and the fitness application (corresponding to the screen button 615), but the invention is not limited thereto.

After the transition screen 610, the touch display 110 may display the application list 620. At this time, the touch display 110 may scroll the screen buttons 612-615 according to the direction of the sliding operations. For example, when the user slides upward, the touch display 110 may scroll up to show screen buttons corresponding to other applications (e.g., the stock application); when the user slides downward, the touch display 110 may scroll down to show screen buttons corresponding to applications such as the fitness application and the music application. Next, when the user finds the desired application, the user may touch the corresponding screen button, and the processing unit 120 may execute the selected application and display related pages.

Therefore, when the user wants to quickly access the desired application, instead of finding the desired application by sliding the icon pages one by one, the user may perform the long touch operation to the main page of the currently executing application. Afterwards, the touch display 110 may switch to the application list (e.g., the applications list 620) for facilitating the user to quickly find the desired application.

In some embodiments, since part of the applications in the electronic apparatus 100 may be related to the mobile phone, when the wireless connection between the communication unit and the mobile phone disappears, the applications in the electronic apparatus 100 may be correspondingly adjusted.

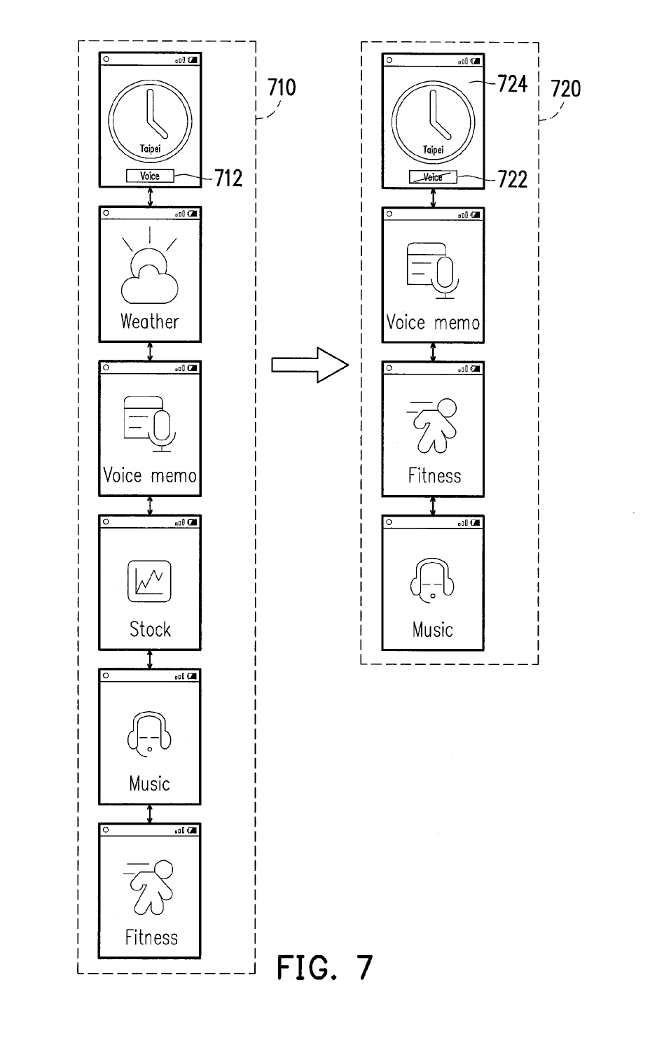

FIG. 7 is a schematic diagram illustrating the related applications without the wireless connection between the electronic apparatus and the mobile phone according to an exemplary embodiment of the present invention. In the present embodiment, when the wireless connection between the communication unit and the mobile phone exists, the accessible applications of the electronic apparatus 100 may be referred to an application configuration 710. However, since some specific applications (such as the weather application and the stock application) may need the communication unit to retrieve the data or information from the mobile phone through the wireless connection, the specific applications would be less useful when the wireless connection disappears.

Hence, when the wireless connection disappears, the processing unit 120 may disable the applications related to the mobile phone. In detail, the accessible applications of the electronic apparatus 100 may be adjusted to an application configuration 720, where the applications related to the mobile phone are temporarily hidden, i.e., the weather application and the stock application. In other words, when the wireless connection disappears, the processing unit 120 may hide the specific applications related to the mobile phone.

Besides, when the wireless connection between the communication unit and the mobile phone disappears, the processing unit 120 may disable functions related to the mobile phone. For example, the processing unit 120 may change a voice dial button 712 to a disabled voice dial button 722 for representing the voice dial function is currently disabled. Furthermore, when the touch display 110 detects a rightward sliding operation while displaying a display screen 724 (corresponding to the clock application), the touch display 110 may display a notification message for notifying the user that there is no wireless connection between the electronic apparatus and the mobile phone.

From another point of view, when the wireless connection exists, the touch display 110 would switch to the notification page (e.g., the notification page 470 in FIG. 4) as receiving the rightward sliding operation while displaying a display screen 724. However, since the wireless connection disappears, the notification page cannot show the notifications related to the mobile phone, and the contents of the notification page may be adjusted to be the notifications message for notifying the disconnection of the wireless connection, but the invention is not limited thereto.

In some embodiments, since the communication unit may establish the wireless connection with the mobile phone and access data and information from the mobile phone, the touch display 110 may display some pop-up notifications related to the mobile phone. Each of the pop-up notifications may have a representative icon field and a notification content field. The representative icon field may show an icon related to the pop-up notification, and the notification content field may show detailed information related to the pop-up notification.

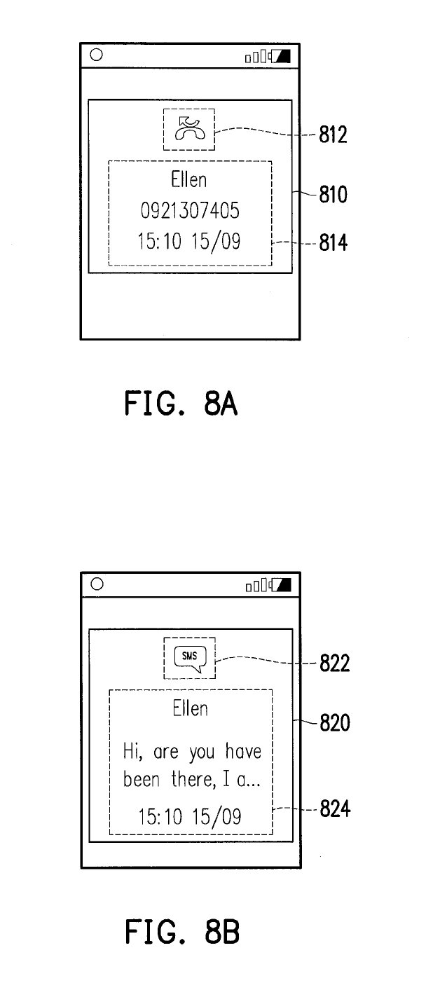

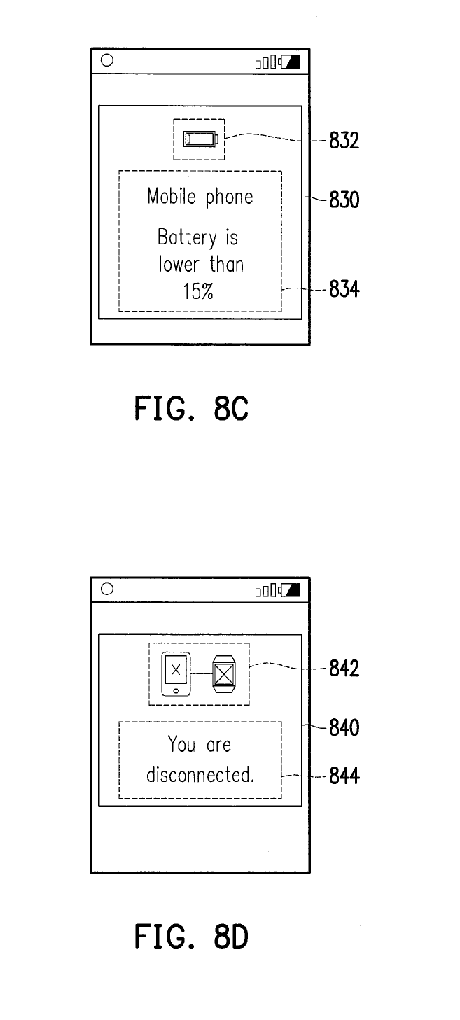

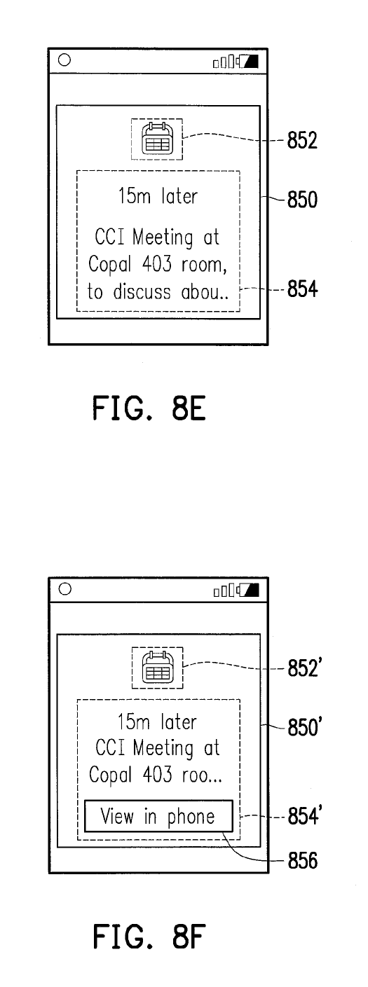

FIG. 8A is a schematic diagrams illustrating the pop-up notification of a missed call related to the mobile phone according to an exemplary embodiment of the present invention. In the present embodiment, when there is a missed call occurs on the mobile phone, the touch display 110 may correspondingly show a pop-up notification 810. The pop-up notification 810 includes a representative icon field 812 and a notification content field 814. The representative icon field 812 may show an icon related to the pop-up notification 810, such as a missed call sign. The notification content field 814 may show detailed information related to the pop-up notification 810, such as the caller name, the missed phone number, the time and the date of the missed call, but the invention is not limited thereto.

FIG. 8B is a schematic diagram illustrating the pop-up notification of a message related to the mobile phone according to an exemplary embodiment of the present invention. In the present embodiment, when there is a message received by the mobile phone, the touch display 110 may correspondingly show a pop-up notification 820, which includes a representative icon field 812 and a notification content field 814. The representative icon field 822 may show a message sign, and the notification content field 824 may show the sender, the contents, the time and the date of the received message, but the invention is not limited thereto.

FIG. 8C is a schematic diagram illustrating the pop-up notification of a low battery condition related to the mobile phone according to an exemplary embodiment of the present invention. In the present embodiment, when there is a low battery condition occurs on the mobile phone, the touch display 110 may correspondingly show a pop-up notification 830, which includes a representative icon field 832 and a notification content field 834. The representative icon field 832 may show a battery sign, and the notification content field 834 may show the current battery condition of the mobile phone, e.g., “Battery is lower than 15%”, but the invention is not limited thereto.

FIG. 8D is a schematic diagram illustrating the pop-up notification of disconnection of the wireless connection according to an exemplary embodiment of the present invention. In the present embodiment, when the wireless connection between the communication unit and the mobile phone disappears, the touch display 110 may correspondingly show a pop-up notification 840, which includes a representative icon field 842 and a notification content field 844. The representative icon field 842 may show a disconnection sign, and the notification content field 844 may indicate that the wireless connection has disappeared, but the invention is not limited thereto.

In some embodiments, the touch display 110 may display the pop-up notification 840 according to the communication distance of the wireless connection. For example, assuming that the wireless connection is established according to the Bluetooth communication standard, when the processing unit 120 determines that the distance between the electronic apparatus and the mobile phone is over the standardized communication distance (e.g., 10 meters) of the Bluetooth communication standard, the touch display 110 may automatically pops out the pop-up notification 840 for indicating the disconnection of the wireless connection.

FIG. 8E is a schematic diagram illustrating the pop-up notification of a calendar event related to the mobile phone according to an exemplary embodiment of the present invention. In the present embodiment, when a calendar event is going to happen, the touch display 110 may correspondingly show a pop-up notification 850, which includes a representative icon field 852 and a notification content field 854. The representative icon field 852 may show a calendar sign, and the notification content field 854 may show the detailed information of the calendar event, such as the time and the contents, but the invention is not limited thereto.

FIG. 8F is another schematic diagram illustrating the pop-up notification of a calendar event related to the mobile phone according to the embodiment of FIG. 8E. In the present embodiment, the difference between FIG. 8E and FIG. 8F is that the notification content field 854 further includes a view in phone button 856. In detail, since the size of the touch display 110 is similar to a common watch, it would be difficult for the user to read all of the contents of the pop-up notification on the touch display 110. Hence, before the touch display 110 shows the pop-up notification 850′, the processing unit 120 may determine whether the contents of the pop-up notification 850′ are over a predetermined threshold (e.g., 50 characters). If yes, the touch display 110 may display the view in phone button 856 as shown in FIG. 8F. When the touch display 110 detects that the view in phone button 856 has been touched, the processing unit 120 may control the mobile phone to display the contents of the pop-up notification 850′. As a result, the user may read the contents of the pop-up notification 850′ on the mobile phone in a more comfortable way.

Besides, in other embodiments, the touch display 110 may further display a speak-out button (not shown) in the pop-up notification 850′. The speak-out button may be configured for controlling the electronic apparatus 100 to read out the contents of the pop-up notification 850′ through a speaker or the like. Therefore, when the user cannot read the contents of the pop-up notification 850′ (e.g., when the user is driving), the user may control the electronic apparatus 100 to read out the contents of the pop-up notification 850′ by touching the speak-out button.

It should be noted that the touch display 110 may display the view in phone button and/or the speak-out button in all types of the pop-up notifications, instead of just in the pop-up notifications related to the calendar event. For example, if the contents of the pop-up notification of the messages are over the predetermined threshold, the touch display 110 may also display the view in phone button and/or the speak-out button in the pop-up notification of the messages, but the invention is not limited thereto.

On the other hand, if the processing unit 120 determines that the contents of the pop-up notification 850′ are not over the predetermined threshold (e.g., 50 characters), the touch display 110 may directly show the contents of the pop-up notification 850′. Meanwhile, the touch display 110 may also show the speak-out button for the user to control the electronic apparatus 100 to read out the contents of the pop-up notification 850′.

In some embodiments, since the communication unit may be connected with the mobile phone, the electronic apparatus 100 may provide calling functions through the wireless connection.

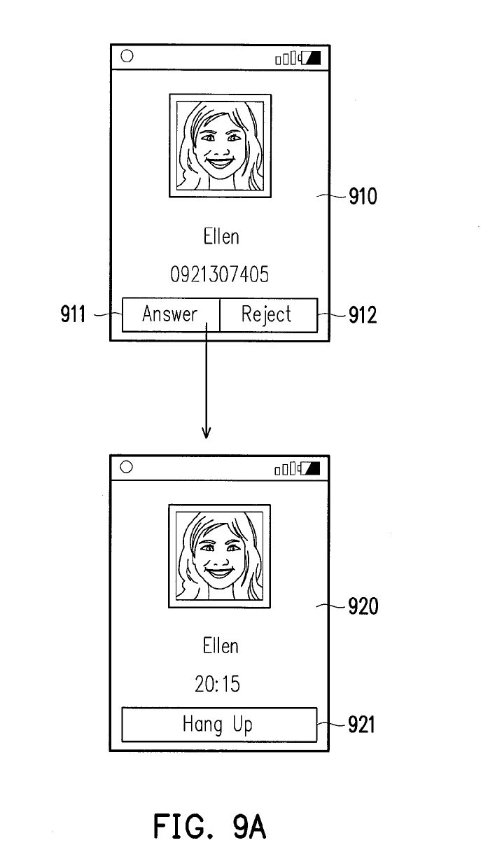

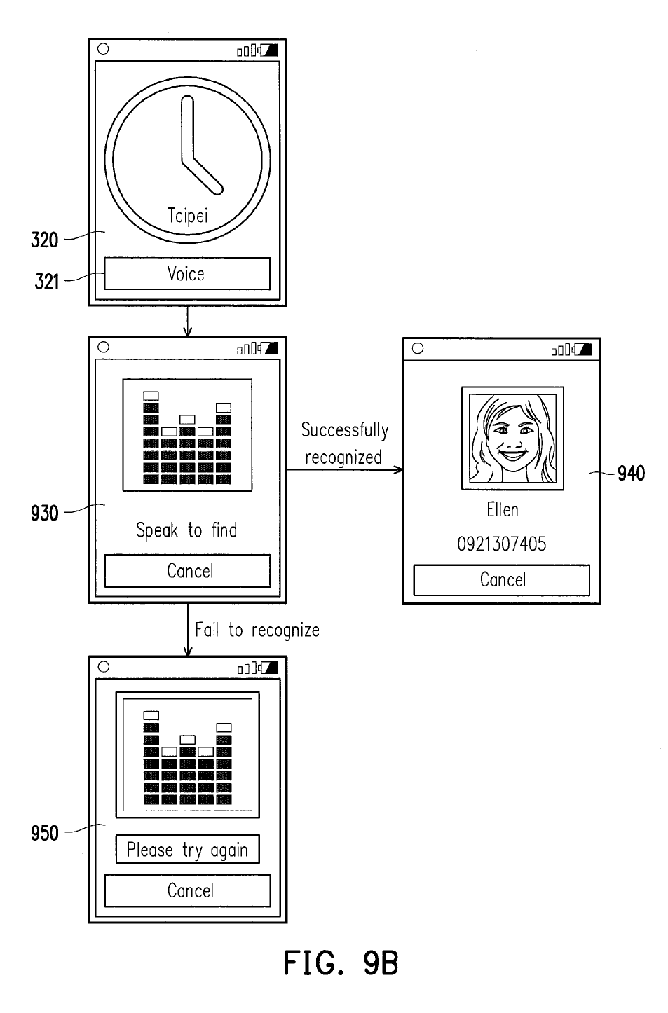

FIG. 9A is a schematic diagram illustrating processing an incoming call of the mobile phone according to an exemplary embodiment of the present invention. In the present embodiment, the touch display 110 may correspondingly display an incoming call page 910 after detecting that the mobile phone has received an incoming call. The incoming call page 910 may include information of the caller (e.g., the thumbnail, the name and the phone number of the caller), an answer button 911 and a reject button 912. When the user wants to pick up the incoming call, the user may press the answer button 911, and the communication unit may pick up the incoming call and switch to a calling window 920 after detecting that the answer button 911 has been pressed. Herein, the user may directly use the electronic apparatus 100 to communicate with the caller through the communication elements of the electronic apparatus 100, such as a speaker (not shown) and a microphone (not shown). When the user wants to finish the call, the user may press a hang up button 921 to end the call.

FIG. 9B is a schematic diagram illustrating performing the voice dial function to the mobile phone according to an exemplary embodiment of the present invention. In the present embodiment, since the electronic apparatus 100 may be connected with the mobile phone, the user may dial the mobile phone through the voice dial button 321 of the touch display 110. When the voice dial button 321 is pressed, the touch display 110 may switch to a voice recognition page 930, and a voice recognizing unit (not shown) of the processing unit 120 may be configured to perform a voice recognition operation to recognize the contents spoke by the user.

If the voice recognizing unit successfully recognizes the contents spoke by the user, the touch display 110 may switch to a calling page and control the mobile phone to make the call. For example, when the user wants to call for a friend named “Ellen”, the user may press the voice dial button 321 while the touch display 110 is displaying the home screen 320. After the touch display 110 switches to the voice recognition page 930, the user may speak “Ellen”. If the voice recognizing unit successfully recognizes the word “Ellen” and find the corresponding contact, the touch display 110 may switch to a calling page 940 and control the mobile phone to make the call for Ellen. Afterwards, when Ellen picks up the call, the user may also communicate with Ellen through the communication elements of the electronic apparatus 100, such as the speaker (not shown) and the microphone (not shown).

However, if the voice recognizing unit fail to recognize the contents spoke by the user, the touch display 110 may switch to display a retry page 950 to facilitate the user to perform another voice input to the electronic apparatus 100.

As a result, the provided communication functions of the electronic apparatus 100 may make the user be able to directly make a phone call or pick up a phone call through the electronic apparatus 100 without operating the mobile phone.

To sum up, the embodiments of the present invention provide a method for switching applications in a user interface and the electronic apparatus using the same. In the embodiments of the present invention, the electronic apparatus may make the user to execute the desired application with a sliding operation. That is, when the user wants to use a desired application, the user may simply slide to the icon page of the desired application and wait for the predetermined time (e.g., 2 seconds), and then the electronic apparatus would correspondingly execute the desired application. As a result, the embodiments of the present invention provide a novel, simple and intuitive way to switch applications in the user interface of the electronic apparatus. Besides, the electronic apparatus may switch to display the main page, the sub page and the detailed page according to the user's sliding operation, and therefore provides the user a convenient way to browse the contents of the applications. That is, the user may control the electronic apparatus to switch between the main page, the sub page and the detailed page of the desired application by the sliding operation.

Furthermore, since the electronic apparatus may provide communication functions by the communication elements, the electronic apparatus may make the user be able to directly make a phone call or pick up a phone call on the electronic apparatus. Therefore, the embodiments of the present invention further provide a new way of executing the calling functions.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for switching applications in a user interface, adapted for an electronic apparatus, the method comprising:
executing a first application after being unlocked;
detecting a sliding operation;
determining whether the sliding operation matches a first direction or a second direction;
if yes, correspondingly displaying an icon page of a second application;
determining whether the sliding operation matching the first direction or the second direction is detected again in a predetermined time; and
if no, executing the second application.

2. The method as claimed in claim 1, wherein after the step of determining whether the sliding operation matches the first direction or the second direction, the method further comprising:
when the sliding operation does not match the first direction or the second direction, displaying corresponding pages according to a direction of the sliding operation.

3. The method as claimed in claim 1, wherein after the step of determining whether the sliding operation matching the first direction or the second direction is detected again in the predetermined time, the method further comprising:
when the sliding operation matching the first direction or the second direction is not detected again in the predetermined time, correspondingly displaying another icon page of another application.

4. The method as claimed in claim 1, wherein the step of executing the second application comprising:
displaying a main page of the second application; and
displaying corresponding pages according to a direction of the sliding operation,
wherein when the direction of the sliding operation matches a third direction, displaying a notification page.

5. The method as claimed in claim 1, wherein after the step of executing the second application, the method further comprising:
switching to an application list in response to a long touch operation,
wherein the applications list consists of a plurality of applications of the electronic apparatus.

6. The method as claimed in claim 1, further comprising establishing a wireless connection with a mobile phone.

7. The method as claimed in claim 6, further comprising displaying at least one pop-up notification related to the mobile phone, wherein the at least one pop-up notification includes a calendar event, a message, a missed call, a battery condition of the mobile phone and a disconnection of the wireless connection.

8. The method as claimed in claim 6, further comprising providing calling functions through the wireless connection.

9. The method as claimed in claim 8, wherein the step of providing the calling functions through the wireless connection comprising:
displaying an incoming call page after detecting that the mobile phone has received an incoming call, wherein the incoming call page includes an answer button; and
picking up the incoming call after detecting the answer button has been pressed.

10. The method as claimed in claim 6, wherein when the wireless connection disappears, hiding at least one specific application related to the mobile phone.

11. An electronic apparatus, comprising:
a touch display; and
a processing unit, coupled to the touch display and configured to execute the program instructions to execute a method for switching applications in a user interface, comprising:
executing a first application after being unlocked;
controlling the touch display to detect a sliding operation;
determining whether the sliding operation matches a first direction or a second direction;
if yes, controlling the touch display to correspondingly displaying an icon page of a second application;
determining whether the sliding operation matching the first direction or the second direction is detected again in a predetermined time; and
if no, executing the second application.

12. The electronic apparatus as claimed in claim 11, wherein when the processing unit determines that the sliding operation does not match the first direction or the second direction, the touch display displays corresponding pages according to a direction of the sliding operation.

13. The electronic apparatus as claimed in claim 11, wherein when the processing unit determines that the sliding operation matching the first direction or the second direction is not detected again in the predetermined time, the touch display correspondingly displays another icon page of another application.

14. The electronic apparatus as claimed in claim 11, wherein after the processing unit executes the second application, the touch display displays a main page of the second application, and displays corresponding pages according to a direction of the sliding operation,
wherein when the processing unit determines that the direction of the sliding operation matches a third direction, the touch display displays a notification page.

15. The electronic apparatus as claimed in claim 11, wherein after the processing unit executes the second application, the touch display switches to an application list in response to a long touch operation, wherein the applications list consists of a plurality of applications of the electronic apparatus.

16. The electronic apparatus as claimed in claim 11, further comprising a communication unit, configured for establishing a wireless connection with a mobile phone.

17. The electronic apparatus as claimed in claim 16, wherein the touch display displays at least one pop-up notification related to the mobile phone, wherein the at least one pop-up notification includes a calendar event, a message, a missed call, a battery condition of the mobile phone and a disconnection of the wireless connection.

18. The electronic apparatus as claimed in claim 16, wherein the communication unit further provides calling functions through the wireless connection.

19. The electronic apparatus as claimed in claim 18, wherein the touch display displays an incoming call page after the communication unit detects that the mobile phone has received an incoming call, wherein the incoming call page includes an answer button; and the communication unit picks up the incoming call after detecting the answer button has been pressed.

20. The electronic apparatus as claimed in claim 16, wherein when the wireless connection disappears, the processing unit hides at least one specific application related to the mobile phone
